(19) United States
(12) Patent Application Publication
(10) Pub. No.: US 2002/0148074 A1
(43) Pub. Date: Oct. 17, 2002

(54) Shock absorbing door stop for vehicles

(75) Inventor: Vittorio Audisio, Milano (IT)

Correspondence Address: SUGHRUE MION, PLLC, 2100 PENNSYLVANIA AVENUE, N.W., WASHINGTON, DC, 20037, US

(73) Assignee: GAMMASTAMP SPA

(21) Appl. No.: 10/102,654

(22) Filed: Mar. 22, 2002

(30) Foreign Application Priority Data
Apr. 13, 2001 (EP) 01830256.2

(51) Int. Cl. E05D 11/10

(52) U.S. Cl. 16/344

(57) ABSTRACT

Door stop for vehicles comprising:

a supporting structure (28) connected to a pair of rollers (38, 48) elastically biased one against the other, and

a tie-rod (12) with a pair of rolling surfaces (16, 18) on which said rollers (38, 48) act, the tie-rod (12) being equipped with a plurality of positioning notches (20, 22, 24) on at least one of said rolling surfaces (16, 18).

The device comprises elastic means (62; 100, 102) arranged between said supporting structure (28) and fastening means (50; 92) for connecting the supporting structure (28) to the door (78) of a vehicle, so that a relative movement between the supporting structure (28) and said fastening means (50, 92) generates a compression of said elastic means (62, 100, 102).

This invention relates to a door stop for vehicles, according to the preamble of claim 1.

Known door stops comprise a tie-rod, one extremity of which pivots on the vehicle body and having a pair of opposite rolling surfaces, on which a pair of idle rollers, elastically pushed one against the other, act. The rollers are connected to a supporting structure fastened to the door of the vehicle. Retainer seats are formed on at least one of the rolling surfaces of the tie-rod. These are engaged when one of said rollers holds the tie-rod in position when the door is either partially or fully open.

The problem which originated this invention is that operators making door-to-door deliveries using vans or similar often leave the door open when driving very short distances. Also providing the vehicle moves very slowly on these short distances, sudden braking of the vehicle impresses a very high torque on the hinge axis of the open vehicle door, which is contrasted by the door stop. It has been noticed that, in vehicles used for door-to-door deliveries, the areas of the door where the door stop is fastened show very evident deformations, also after relatively short periods of use.

The object of this invention is to provide an improved door stop which overcomes said problems.

According to this invention, this object is reached by means of a door stop which characteristics are described in the main claim.

This invention will be better explained by the following detailed descriptions with reference to the accompanying figures, given as non-limiting example, wherein:

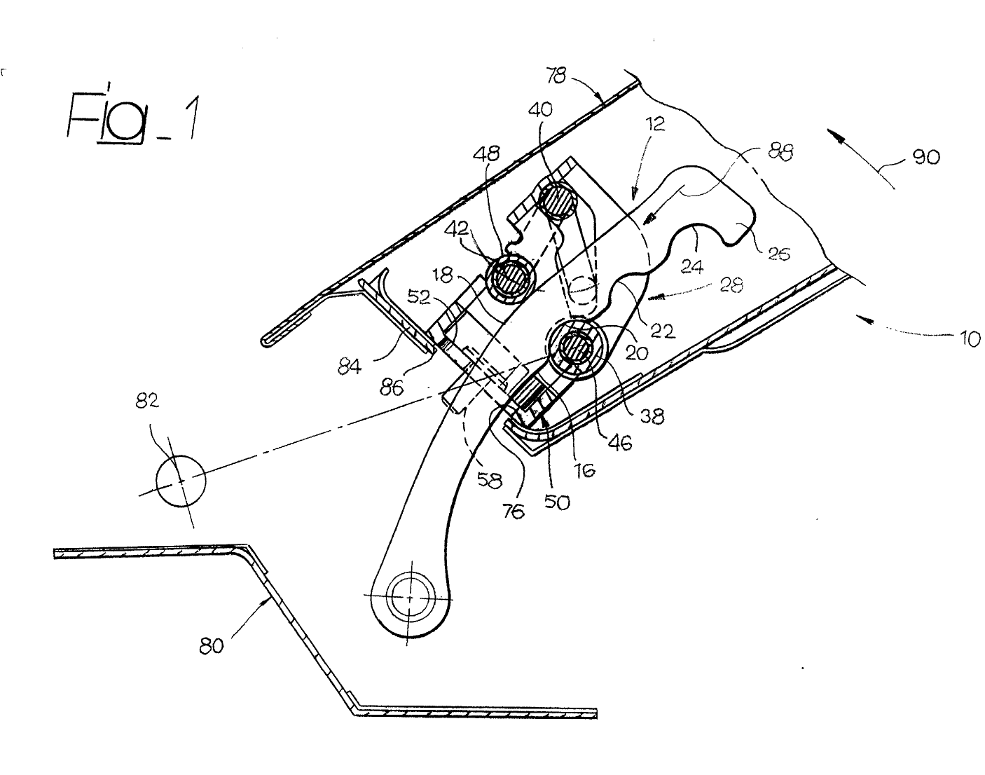

FIG. 1 is a cross-section plan view illustrating a first form of embodiment of a door stop according to this invention,

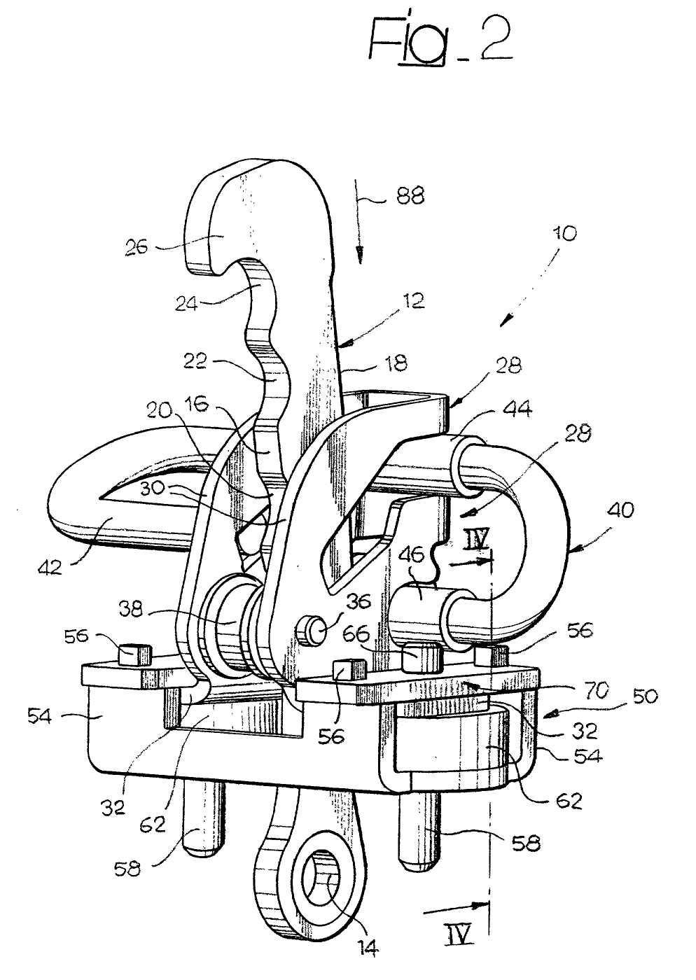

FIG. 2 is a perspective view of the door stop in FIG. 1,

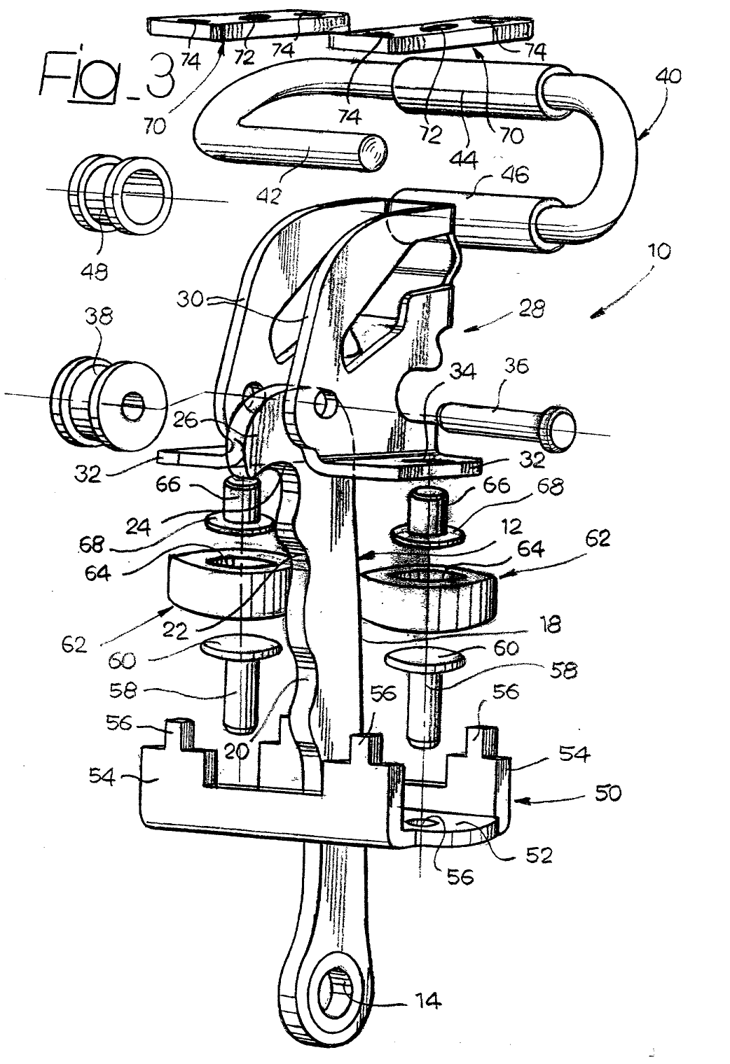

FIG. 3 is a perspective exploded view of the door stop in FIG. 1,

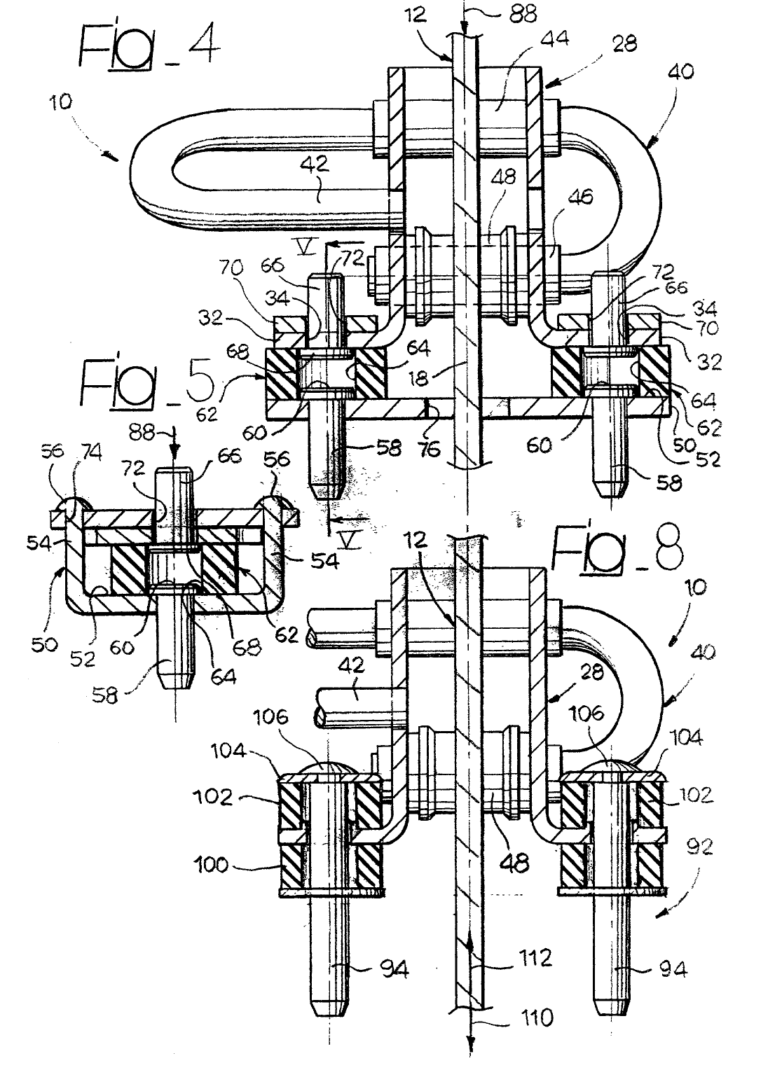

FIG. 4 is a cross-section according to the line IV-IV in FIG. 2,

FIG. 5 is a cross-section according to the line V-V in FIG. 4,

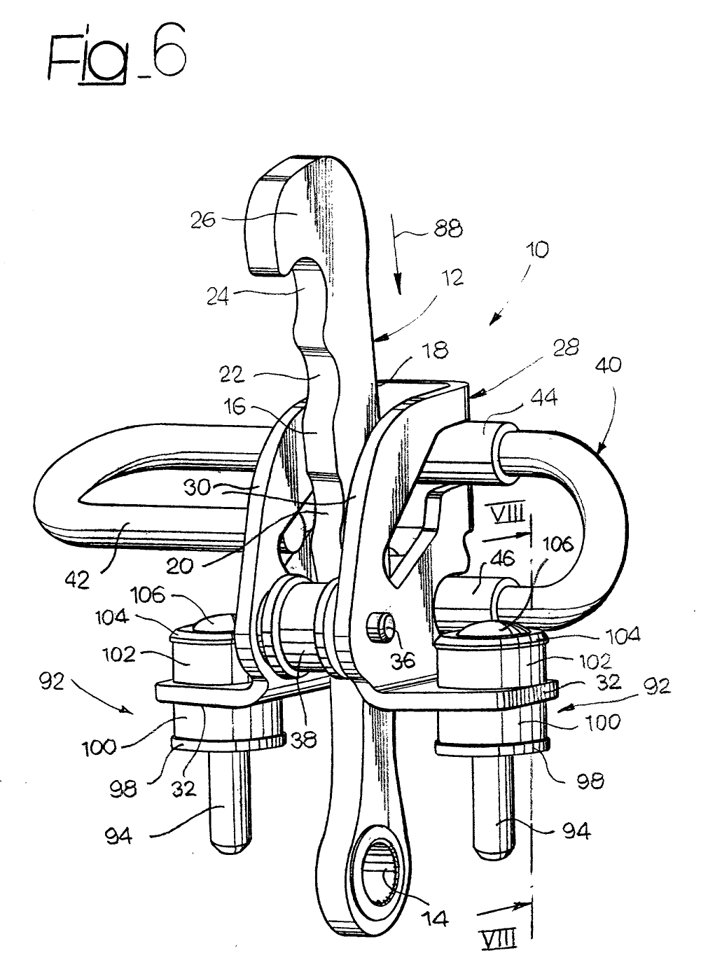

FIG. 6 is a perspective view illustrating a second form of embodiment of the door stop according to this invention,

FIG. 8 is a cross-section according to the line VIII-VIII in FIG. 6 and

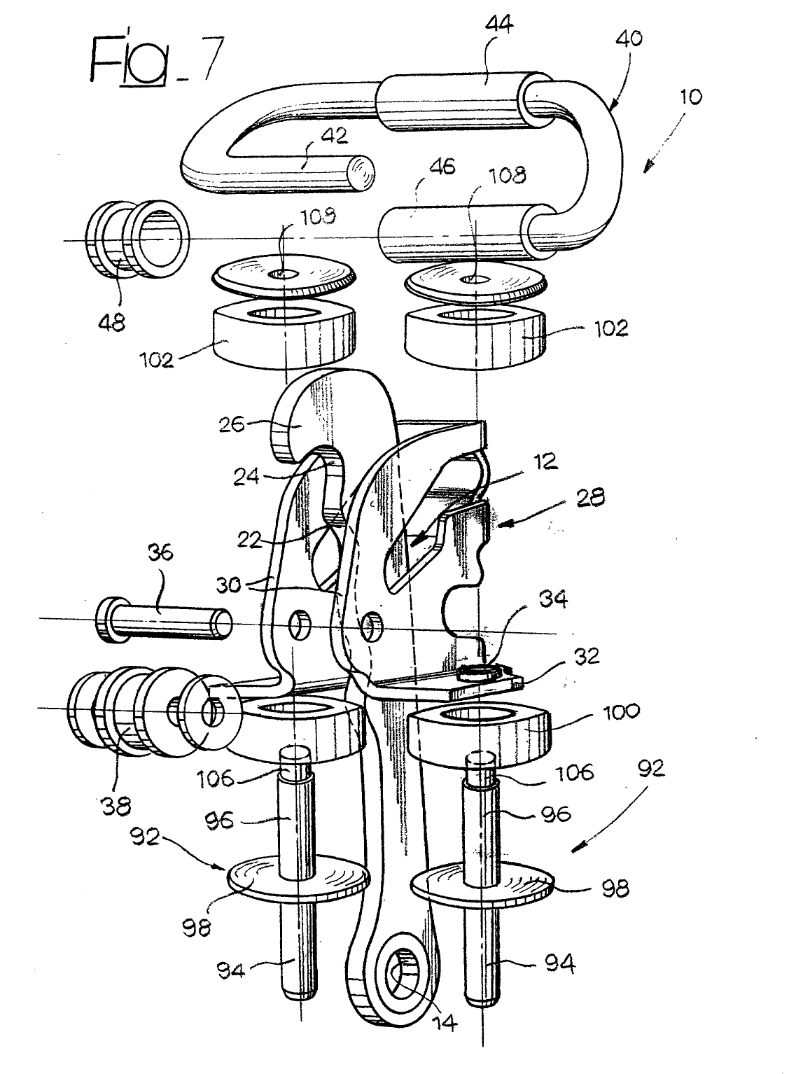

FIG. 7 is perspective exploded view of the door stop in FIG. 6.

With reference to FIG. from 1 to 6, a door stop according to a first form of embodiment is indicated by numeral 10. The door stop 10 comprises a metallic tie-rod 12 with a joint hole 14 on one extremity. The tie-rod 12 has two opposite rolling surfaces 16, 18. In the form of embodiment illustrated in the figures, the rolling surface 18 is essentially smooth, while the rolling surface 16 presents a set of positioning notches 20, 22 and 24, which define two positions of partially open door and a position of entirely open door. The notch 24, defining the position of completely open door, is associated with a retaining portion 26 shaped as a hook, formed on one extremity of the tie-rod 12.

The door stop device 10 comprises a supporting structure 28 consisting of sheared, pressed metallic sheet. The supporting structure 28 has two parallel sides 30 facing each other, which extremities are bent outwards forming a pair of fins 32 with respective holes 34. The parallel sides 30 of the supporting structure 28 are connected to a pin 36, on which a first roller 38 turns and co-operates with the first rolling surface 16 of the tie-rod 12. The supporting structure 28 is connected to a metallic rod spring 40 with a first extremity 42, an intermediate section 44 and a second extremity 46. Preferably, co-moulded plastic material coatings are applied on the intermediate section 44 and on the second extremity 46. A second roller 48 acting on the second rolling surface 18 of the tie-rod 12 under the elastic load generated by the spring 40 turns on the second extremity 46 of the spring 40.

The door stop device 10 comprises a fastening structure 50 for fastening the supporting structure 28 to the door of the vehicle. The fastening structure 50 comprises a sheared, bent sheet element, with a bottom side 52 and two parallel lateral sides 54. The bottom side 52 is equipped with a pair of holes 56, while the lateral sides 54 present two pairs of fastening elements to be riveted 56, formed and integrally to the sides 54. A pair of fastening pins 58 are inserted in the holes 56 of the fastening structure 50. The pins 56 have respective heads 58 resting on the internal surface of the bottom side 52. The cylindrical portions of the pins 52 projecting from the external side of the structure 50 are used to secure the door to the fastening structure 50.

The fastening structure 50 comprises a pair of elastic elements 62 made in the shape of elastomer material rings. Each elastic element 62 rests on the bottom side 52 of the fastening structure 50 and receives inside the cavity 64 the head 60 of the respective pin 58. A second pair of pins 66 is fastened in holes 34 of the fins 32. The pins 66 have respective heads 68, which are inserted inside the cavities 64 of the elastic elements 62 on the opposite side with respect to the heads 60 of the pin 58 (see in particular FIGS. 4 and 5). The part of the fastening structure 50 opposite to the bottom side 52 is closed by means of a pair of plates 70, each of which has a central hole 72 and a pair of extremity holes 74. With reference to the exploded view in FIG. 3, the following elements are overlaid on the bottom side 52 of the fastening structure 50, from the bottom upwards: the pins 58, the elastic elements 62, the fins 32 with the respective pins 66 and the plates 70. The pins 66 are engaged so to freely slide in the central holes 72 of the respective plates 70, while the portions to be riveted 56 are inserted inside the extremity holes 74. Assembly is completed by deforming the portions 56 projecting from the opposite part of the plates 70, as clearly appears in FIG. 5. As can be seen in FIGS. 1 and 4, the tie-rod extends through an opening 76 formed in the bottom side 52 of the fastening structure 50.

FIG. 1 illustrates the door stop according to this invention fitted on a door 78 of a vehicle, pivoting on a pillar 80, which is part of the vehicle chassis, around a hinge axis 82. In fitted condition, the hole 14 of the tie-rod 12 pivots on the pillar 80 by means of a pivoting element (not illustrated). The fastening structure 50 is rigidly fastened to the door by means of the pins 58, which are inserted and fastened in the respective holes on the side 84 of the door 78. The opening 76 of the fastening structure 50 is aligned with a respective opening 86 in the side 84 of the door 78, so that the tie-rod 12 is free to slide between the rollers 38, 48 following the opening and closing movement of the door 78. FIG. 1 illustrates the door 78 in a partially open position, in which the roller 48 is positioned so to correspond to the first positioning notch 20. By further opening the door, the roller 38 moves into the second positioning notch 22 to hold the door 78 in a second partially open position, after which the roller 38 engages the third positioning notch 24 when the door reaches the completely open position.

The supporting structure 28 is subject to move with respect to the fastening structure 50 in the direction shown by the arrow 88. During a relative movement between the supporting structure 28 and the fastening structure 50, the fins 32 of the supporting structure 28 compress the elastic elements. The elastic elements 62 are consequently able to absorb high intensity pulsing forces before such forces deform the structure of the door 78. In a condition where the door is completely open, in which the roller 38 is withheld by the hook shaped portion 26 of the tie-rod 12, a force of inertia would tend to additionally move the door 78 in the direction of the arrow 90 in FIG. 1, due, for example, to a sudden braking of the vehicle in open door conditions, producing a movement of the supporting structure 28 in the direction shown by the arrow 88 and such movement compresses the elastic elements 62. In this way, the force applied by the tie-rod 12 to the supporting structure 28 is not directly applied to the structure of the door 78.

FIGS. 6, 7 and 8 illustrate a second form of embodiment of the door stop according to this invention. The elements corresponding to those previously described are indicated with the same numerals. In the second form of embodiment of the device according to this invention, the supporting structure 28, the spring 40 and the tie-rod 12 are essentially identical to those described above. The only difference concerns the fastening structure for the shock absorbing connection of the supporting structure 28 to the door. In this case, a pair of pins 92, each of which has a first cylindrical portion 94 and a second cylindrical portion 96, which are separated by a resting portion 98 in the shape of a plate, are included. The first cylindrical portion 94 of each of the pins 92 is used to fasten to the door and has the same function as the cylindrical part of the pins 58 in the previously described form of embodiment. The following are inserted on the second cylindrical portion 96, from the bottom upwards, with reference to the direction of FIGS. 6, 7 and 8: a first elastic element 100, the hole 34 of the fin 32 of the supporting structure 28, a second elastic element 102 and a closing plate 104 which is fastened to an extremity 106 of the respective pin 92 by riveting the extremity 106 after insertion in a hole 108 of the plate 104. With reference to FIGS. 6 and 8, in the assembled configuration, the first elastic element 100 is arranged between the fin 32 and the resting portion 98 of the pin 32, while the second elastic element 102 is arranged between the fin 32 and the plate 104, which is solidly fastened to the pin 92. In this way, the supporting structure 28 can move with respect to the pins 92 in the directions shown by the arrows 110 and 112. When the supporting structure moves with respect to the pins 92 in the direction of arrow 110, the first elastic elements 100 are compressed; conversely, when the supporting structure 28 moves with respect to pins 92 in the direction of arrow 112, the second elastic elements 102 are compressed. This alternative embodiment of the invention permits the absorption of energy by means of the elastic elements 100 and 102 both when the end of stroke position is reached with high speed and when the supporting structure 28 bounces following the release of residual elastic energy accumulated by the elastic elements 100 during compression. The elastic elements 100, 102 are also compressed, to a smaller extent, when engaging and releasing the intermediate positioning notches 22, 24 by the roller 38. This confers greater positivity and smoother, more fluid operation to the device.

1. Door stop for vehicles comprising:
a supporting structure (28) connected to a pair of rollers (38, 48) elastically biased one against the other, and
a tie-rod (12) with a pair of rolling surfaces (16, 18) on which said rollers (38, 48) act, the tie-rod (12) being equipped with a plurality of positioning notches (20, 22, 24) on at least one of said rolling surfaces (16, 18),
characterised in that it comprises elastic means (62; 100, 102) arranged between said supporting structure (28) and fastening means (50; 92) for connecting the supporting structure (28) to the door (78) of a vehicle, so that a relative movement between the supporting structure (28) and said fastening means (50, 92) generates a compression of said elastic means (62, 100, 102).

2. Device according to claim 1, characterised in that said elastic means comprise at least an annular element (62; 100, 102) made of deformable material.

3. Device according to claim 1, characterised in that said fastening means (50) comprise a metallic structure with a bottom side (52) and a pair of fastening pins (58) projecting from said bottom side (52), said elastic means (62) being arranged between a portion (32) of the supporting structure (28) and said bottom side (52).

4. Device according to claim 1, characterised in that said fastening means (92) comprise a pair of pins (92) each of which has two cylindrical portions (94, 96), separated by a resting portion (98) in the shape of a plate, in which a first elastic element (100) is arranged between a portion (32) of said supporting structure (28) and said resting portion (98) of said pin (92).

5. Device according to claim 4, characterised in that a second elastic element (102) is arranged between said portion (32) of the supporting structure (28) and a plate (104) fastened to each of said pins (92).
